(19) United States
(12) Patent Application Publication
(10) Pub. No.: US 2025/0299260 A1
(43) Pub. Date: Sep. 25, 2025

(54) System and Related Methods for Centralized Management of Insurance Product Versions

(71) Applicant: Ajith Chakrampilly Thomas, South Ogden, UT (US)

(72) Inventor: Ajith Chakrampilly Thomas, South Ogden, UT (US)

(21) Appl. No.: 18/608,991

(22) Filed: Mar. 19, 2024

(51) Int. Cl. G06Q 40/08; G06Q 10/0631; G06Q 10/0635; G06Q 30/0201

(52) U.S. Cl. CPC G06Q 40/08; G06Q 10/063112; G06Q 10/0635; G06Q 30/0201

(57) ABSTRACT

The present invention relates to a system for managing various versions of insurance products. This system integrates a database for storing detailed insurance product data, including rates, rules, and forms, aligned with the specific business lines and jurisdictions. Servers are connected to this database to execute several key functions: they process rule sets via a rules engine, manage a detailed audit trail of product modifications, and provide interfaces for configuring product versions as per state-specific regulations. Furthermore, the servers enable seamless communication with external systems for compliance verification and filing purposes. Client devices are also part of the system, designed to facilitate user interaction, allowing access to product data, enabling the management of product version upgrades, and permitting the customization of workflows in accordance with user roles.

### FIELD OF INVENTION

The present invention relates generally to the field of insurance product management systems. More particularly, it relates to software systems and methods for the centralized management, versioning, and regulatory compliance of insurance products across multiple jurisdictions.

### BACKGROUND

In the dynamic and ever-evolving landscape of insurance product management, industry professionals have faced enduring challenges. Actuaries, product managers, and analysts routinely navigate the complexities of managing a multitude of insurance product versions. Each product iteration carries with it a distinctive set of rates, rules, and forms, which historically have not been centralized, resulting in significant barriers to efficient product evolution and compliance adherence.

The traditional methodologies for managing these components are often fragmented and manual, necessitating a multi-month endeavor for each product version upgrade. This approach has inherent inefficiencies, rendering the process time-consuming and prone to errors. Additionally, the adaptation to state-specific regulatory demands further complicates the scenario, demanding meticulous attention to ensure that each product version conforms to the varied regulatory landscapes across states. This is further exacerbated by the need for a rigorous version control system to document changes over time, which is crucial for both internal governance and regulatory compliance.

Inter-departmental collaboration, an essential facet of efficient product management, has historically been hindered by the absence of an intuitive and unified platform. Existing systems frequently fall short in providing the level of integration necessary for seamless interaction among the various stakeholders involved in product management. Moreover, the management of intricate workflows and permissions tailored to distinct roles within an organization often presents an additional layer of complexity.

In the face of such limitations, there has been an emergent need for an innovative solution that offers a consolidated view and streamlined management of insurance product versions. Such a system would revolutionize the industry by significantly reducing the time required for version upgrades, enhancing collaborative efforts, ensuring compliance, and maintaining a comprehensive audit trail of changes for each product iteration. The drive towards this advancement has been fueled by the necessity to simplify the product management process while maximizing efficiency and accuracy, ultimately benefitting the insurance firms' operations and their capacity to serve their clients effectively.

It is within this context that the present invention is provided.

### SUMMARY

The present invention is directed to a comprehensive insurance product version management system comprising at least one database to store a diverse array of insurance product data, including rates, rules, form documents, and version history, tailored to various business lines and compliance requirements.

This system incorporates a database for storing detailed data related to insurance products, including rates, rules, forms, and historical version information. The setup includes servers connected to this database, responsible for various functions that streamline the management of insurance products. These functions include processing rule sets relevant to insurance products, tracking changes through an audit trail, configuring insurance product versions to comply with state-specific regulations, and facilitating necessary communication with external systems for compliance and filing purposes. Client devices allow users to interact with the system. Through these devices, users have the ability to review insurance product data stored in the database, oversee and execute updates to product versions, tailor workflow processes based on specific roles and permissions, and manage insurance product forms to ensure alignment with respective business and regulatory demands.

In some embodiments, the system allows for the customization of workflows based on user roles and permissions. This feature allows for personalized interaction with the system, facilitating ease of use and improving operational efficiency for different user types within an organization.

In some embodiments, the system includes an API connector layer that enables the one or more servers to integrate with a variety of external systems. This integration is designed to enhance communication and data exchange capabilities, thereby streamlining various aspects of insurance product management.

In some embodiments, the one or more servers are capable of maintaining a structured data schema that utilizes normalization techniques and indexing. This organization of data aids in efficient storage and retrieval, which can be particularly beneficial when handling large volumes of complex insurance product information.

In some embodiments, the system incorporates multiple security measures, including encryption protocols, access controls, and secure communication channels. These measures are implemented to protect sensitive data and ensure system integrity and reliability.

In some embodiments, the system features a rules engine integration that allows for real-time synchronization of rule-related data between the system and an integrated rules engine through the API connectors. This allows for immediate updates and consistency across the system.

In some embodiments, the system is designed to store a versioned history of business rules in the at least one database. This enables the one or more client devices to access and manage these rules with precision and control over modifications and version tracking.

In some embodiments, the one or more servers facilitate the manual uploading of rules from documentation. This is achieved through document parsing capabilities that allow the structured extraction and inclusion of rules within the at least one database.

In some embodiments, the system includes a user interface for rule definition and modification, which allows users to define and modify business rules through form-based input. This interface simplifies the rule-setting process for users at various technical skill levels.

In some embodiments, the one or more servers are configured to integrate with forms and document management systems. This enables the system to handle the retrieval, storage, and modification of insurance policy forms efficiently, ensuring that both original and modified forms are captured and stored.

In some embodiments, the system is capable of storing modified forms in a centralized location and automates the workflow for form approval processes. This feature aims to optimize the review and approval process by communicating with forms management personnel.

In some embodiments, the one or more client devices permit users to adjust and modify insurance products based on specific lines of business. This capability takes into account regional regulations and coverage variations, thereby enhancing the applicability of the system across various jurisdictions.

In some embodiments, the one or more servers implement analytical capabilities to track the performance of insurance products. By generating reports on key metrics, the system supports data-driven decision-making within the organization.

In some embodiments, the one or more servers can integrate with external data sources to access real-time information. This feature is designed to improve risk assessments and inform product management decisions by utilizing up-to-date external data.

In some embodiments, the system comprises a chatbot integration feature, wherein the one or more servers process user inquiries related to insurance products. This functionality enables the system to provide timely responses to users by leveraging the stored data.

In some embodiments, the system utilizes predictive models for forecasting customer behavior and the likelihood of policy renewals. This anticipatory function assists in customer retention strategies and informed policy management.

In some embodiments, the system incorporates a recommendation engine that suggests product modifications. By analyzing market trends, regulatory changes, and historical data, the engine supports informed decision-making related to product adjustments.

In some embodiments, the system includes tools for monitoring regulatory requirement changes. This aspect of the system ensures that insurance products are automatically updated in the database for ongoing compliance with legal standards.

### BRIEF DESCRIPTION OF THE DRAWINGS

Various embodiments of the invention are disclosed in the following detailed description and accompanying drawings.

FIG. 1 depicts the system architecture for Integration with Various Systems using an API Connector Approach. It shows the central server interfacing with various external systems through API connectors, a centralized database for storing insurance product data, and user devices for interacting with the system.

FIG. 2 illustrates the system architecture for the Decentralized Data Storage Approach, highlighting the separation between the system's interface and the physical storage of insurance product data on client-controlled data servers.

FIG. 3 presents a flow diagram of the steps involved in processing data from a new client's system that has just been added. This includes the identification of the client's specific rule set, loading the rule set into the system's rules engine, processing the rule set, applying the outcomes to the client's data, and verifying the integration and processing success.

FIG. 4 showcases a flow diagram of the steps a user might go through as they log in and use the system. It covers the user journey from the login screen to various functionalities within the product management landing page, including search capabilities, product summary review, workflow tabs for product modification, and product admin tabs for managing administrative tasks.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term ‘database’ refers to any type of storage medium or collection of data that is electronically stored and can be accessed and managed by one or more servers. The database may be implemented using various data storage technologies, including, but not limited to, relational databases such as MySQL, PostgreSQL, or Oracle; NoSQL databases such as MongoDB or Cassandra; or cloud-based storage services such as Amazon S3 or Google Cloud Storage.”

The term ‘rules engine’ as used herein refers to a software system that executes one or more rules against a set of data. Rules engines can be implemented in software systems such as Drools, InRule, or Corticon, which allow for the definition, management, and execution of complex business rules applied to the stored data.

The phrase ‘client devices’ encompasses any electronic device that can interact with the server and database to perform operations, including desktop computers, laptops, tablets, smartphones, or specialized terminals. These devices may operate on various operating systems such as Windows, MacOS, Linux, iOS, or Android, and may use software applications or web browsers to interact with the system.

### DESCRIPTION OF DRAWINGS

Within the framework of the present invention, two primary approaches facilitate the management of insurance product versions, each tailored to meet distinct operational and security requirements.

The first approach, Integration with Various Systems using an API Connector, enables the system to be seamlessly integrated with a variety of external systems, including Policy Administration Systems, Risk Management Systems, Rating Workbooks, Document Management Systems, and Rules Repositories. This is achieved through the use of an API connector that supports efficient communication and data exchange between the system and these external entities. Such integration allows for the dynamic management and storage of insurance product versions, with data organized according to line of business, state, and effective dates. The system is designed to offer customizable workflows, views, and lookups, ensuring a user experience that is tailored to the specific needs and permissions of different roles within an organization. Additionally, the system integration with the System for Electronic Rate & Form Filing (SERFF) enhances the capabilities related to the filing and status checks of insurance products, streamlining their submission and overall management through the electronic filing system.

The second approach, Decentralized Data Storage, positions the system as a platform that facilitates access to and management of insurance product information without directly storing client data. In this model, all client data, including details and related information about insurance products, is stored on the client's own data servers. This architecture ensures that sensitive client data is kept within a controlled environment, directly addressing data security and compliance concerns while mitigating the risk of data breaches. It grants clients the flexibility to choose their data storage solutions and maintain control over the scalability and performance of their data servers, thereby facilitating efficient handling of large volumes of data. This approach eliminates the need for redundant data storage, reducing the risk of inconsistencies and ensuring access to the most current information. It also provides clients with greater autonomy over their data, reducing their dependency on the system for data storage.

Each approach presents distinct advantages: the API connector integration emphasizes a more centralized method for system interaction, while the decentralized data storage approach focuses on enhancing client control over data and security. The selection between these approaches is influenced by various factors, including data security, compliance needs, scalability requirements, and the degree of control desired by the client. The specific needs and preferences of the insurance company adopting the system will ultimately determine the most suitable implementation strategy.

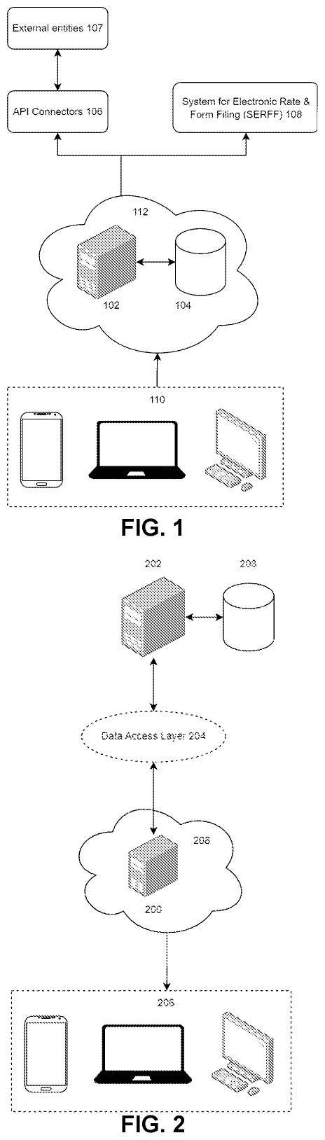

Referring to FIG. 1, an example implementation of a first embodiment of the invention is illustrated, wherein the system architecture for Integration with Various Systems using API Connector Approach is depicted. The architecture showcases the interconnected nature of the system with external systems and internal components designed to facilitate the management of insurance product versions.

At the core of the architecture is the server 102, which operates as the central hub for the system. The server 102 is responsible for executing the main logic of the system, including processing rule sets, managing audit trails, and configuring insurance product versions based on specific regulations and effective dates. This server 102 can be implemented on platforms such as Linux or Windows Server, running server applications like Apache or IIS to handle web requests.

Connected to the server 102 is the database 104, serving as the primary storage for insurance product data, including rates, rules, forms, and version histories. The database 104 could be implemented using relational database management systems (RDBMS) like MySQL or PostgreSQL, or NoSQL databases like MongoDB, depending on the scalability needs and data structure preferences.

The server 102 interfaces with various external systems 107 through API connectors 106. These connectors 106 enable seamless communication and data exchange between the system and external entities 107 such as Policy Administration Systems, Risk Management Systems, Rating Workbooks, Document Management Systems, and Rules Repositories. The API connectors 106 can be built using RESTful APIs or SOAP protocols to ensure wide compatibility and secure data transmission.

One of the key external integrations is with the System for Electronic Rate & Form Filing (SERFF) 108. This integration allows the system to streamline the submission and management of insurance products through the electronic filing system, leveraging protocols that ensure secure and efficient data exchange.

User devices 110, such as desktop computers, laptops, tablets, or smartphones, allow users to interact with the system. These devices 110 connect to the server 102 over a network or internet connection, using web browsers or dedicated applications to access and manage insurance product data. The user interface and experience can be customized based on predefined user roles and permissions, enhancing usability and productivity.

The network 112 facilitates communication between user devices 110, the server 102, and external systems through the API connectors 106. This connection 112 ensures that data flows smoothly and securely across the architecture, enabling real-time access and updates to insurance product information.

Referring to FIG. 2, an example implementation of a second embodiment of the invention is illustrated, wherein the system architecture for the Decentralized Data Storage Approach is depicted. This approach emphasizes the separation between the system's operational logic and the physical storage of insurance product data, leveraging client-controlled data servers to enhance data security and autonomy.

The central component of this architecture is the interface server 200, which hosts the operational logic, user interface, and workflow management of the system. The interface server 200 could be based on robust computing platforms such as cloud services provided by Amazon Web Services (AWS) or Microsoft Azure, equipped with web server software like Apache or NGINX to handle client requests.

Client data servers 202, which are coupled to one or more client databases 203, represent the decentralized storage units where all insurance product-related data, including details, rates, rules, and forms, is stored. These servers 202 could be located within the client's infrastructure or hosted on secure, private cloud environments, ensuring that sensitive data remains under the client's control. The choice of database technologies here can range from RDBMS like Oracle Database to NoSQL solutions like Cassandra, depending on the client's specific data management and performance requirements.

A data access layer 204 facilitates communication between the interface server 200 and the client data servers 202. This layer 204 employs middleware technologies or custom-built services that securely fetch and update data as requested by the system's operations. Protocols such as ODBC (Open Database Connectivity) or JDBC (Java Database Connectivity) can be utilized here for database interactions, ensuring efficient and secure data operations.

User devices 206 allow for direct interaction with the system through the interface server 200. These devices 206 can include a wide range of computing devices such as desktop computers, laptops, tablets, and smartphones. Users access the system via web browsers or dedicated applications, engaging with the system's functionality to manage and review insurance product data.

The network 208 connects user devices 206, the interface server 200, and client data servers 202. This connection 208 ensures the continuous and secure exchange of information across the system, enabling real-time access and responsiveness to user actions and data updates.

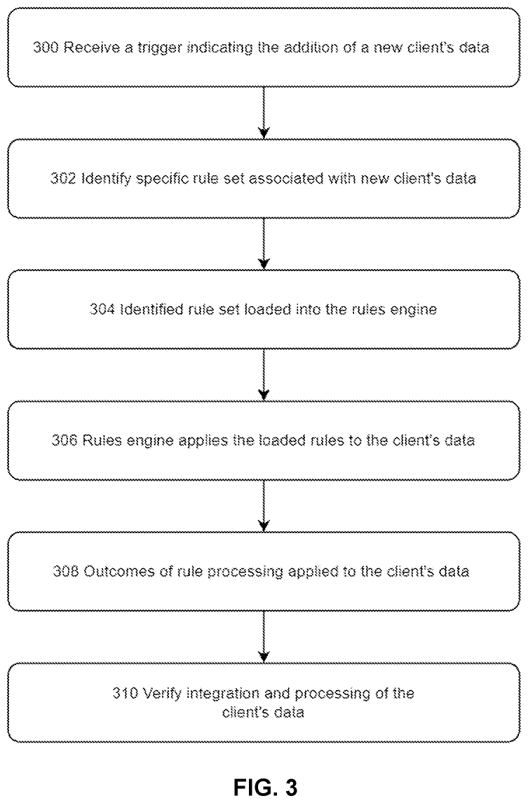

Referring to FIG. 3, a flow diagram is illustrated of a set of steps of an example method carried out by the system of the invention when processing data from a new client's system that has just been added. This process underscores the application of a rules engine to effectively integrate and process rule sets from the client's system, ensuring seamless operation within the broader system architecture.

The method initiates at step 300, where the system receives a trigger indicating the addition of a new client's data to the system. This trigger could be generated through a user interface action performed by an administrator or automatically upon detecting new client data through predefined monitoring services.

Following the initiation, the process advances to step 302, wherein the system identifies the specific rule set associated with the new client's data. This identification process involves querying the database or accessing a predefined location where the client's rule sets are stored. The system ensures that the correct rule set is selected based on the client's unique identifiers and the specific insurance products the client offers.

At step 304, the identified rule set is loaded into the system's rules engine. The rules engine is prepared to process the rules against the newly added client data. This step involves parsing the rule set to understand the conditions, actions, and business logic defined within.

Processing of the rule set by the rules engine is depicted at step 306. During this step, the engine applies the loaded rules to the client's data, executing business logic to validate, modify, or otherwise interact with the data according to the predefined rules. This could involve checking for compliance with insurance regulations, calculating rates based on risk assessments, or any number of operations defined by the rule set.

Upon completion of the rule set processing, the method proceeds to step 308, where the outcomes of the rule processing are applied to the client's data within the system. This might include updating database records, triggering notifications or alerts, or initiating subsequent workflows based on the results of the rule processing.

The final step, 310, involves verifying the successful integration and processing of the client's data. This step could include automated checks to ensure data integrity, compliance with expected outcomes, and the absence of processing errors. Following verification, the system logs the integration event and its outcomes for audit purposes and notifies relevant system users or administrators of the completion.

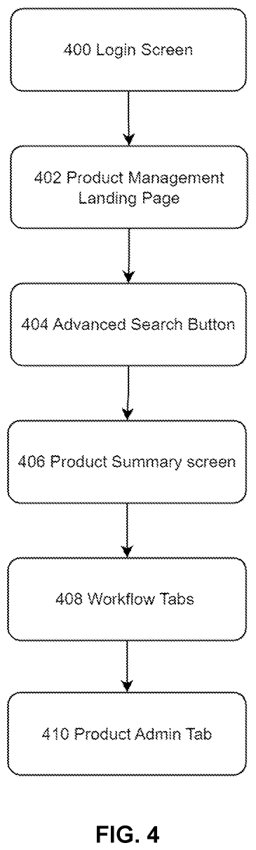

Referring to FIG. 4, a flow diagram is illustrated of a set of steps of a user journey provided by the system of the invention. This journey outlines the interaction of users with the system from login to the management of insurance product details, showcasing the streamlined process facilitated by the system for efficient product management.

The user journey begins at step 400, where the user is presented with a Login Screen. This screen serves as the initial access point to the system, implementing a single sign-on process. Only users with approved credentials are able to log in, ensuring that access to the system is restricted to authorized personnel. The login mechanism could utilize standard authentication protocols such as OAuth 2.0 or SAML for identity verification.

Upon successful login, the user arrives at the Product Management Landing Page at step 402. This page serves as the operational hub for the user, offering various functionalities to manage insurance products. Included on this page is a Search Functionality, allowing users to search for products based on criteria like Line of Business (LOB), State, Product Version, and Product Components. This feature ensures users can quickly find the products they need to manage.

An Advanced Search Button, indicated at step 404, provides users the capability to perform more detailed searches. This might involve querying the system based on policy version, listing Policies in Force (PIF) along with their effective dates. Such advanced search capabilities allow users to drill down into the specifics of insurance products, facilitating detailed management tasks.

At step 406, the user accesses a Product Summary screen, which provides a detailed overview of the selected product from the Product Management Landing Page. This screen utilizes expandable Cards or Boxes to display Rates, Rules, and Forms associated with the product. Clicking on a Card or Box expands it to reveal detailed information, enabling the user to review and manage the product specifics effectively.

Workflow Tabs are introduced at step 408, allowing the user to initiate modifications to various aspects of the product. Users can make changes to Rates, Filings, Underwriting Rules, and Forms. This step signifies the system's capability to support comprehensive product management through a user-friendly interface.

Finally, at step 410, Product Admin Tabs provide users with tools to handle product-related administrative tasks. This includes managing Forms Inventory, Rate Factor Management, Bureau Content, Competitive Analysis, and Profitability Analysis. This comprehensive set of administrative functionalities ensures that users have complete control over the management and optimization of insurance products within the system.

### Network Components

The term ‘server’ as described herein is understood to include any computing device or system of devices that manage network resources. This may include, for instance, application servers, web servers, database servers, or any combination thereof. Examples of server software include Apache HTTP Server, Microsoft Azure, Microsoft Internet Information Services (IIS), NGINX, and Node.js for web services, and Microsoft SQL Server, MySQL, or Oracle Database for database services.

A computing device may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and related methods for centralized management of insurance product versions of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for managing insurance product versions, comprising:
at least one database configured to store insurance product data, including rate information, rule sets, form documents, and version history for a plurality of insurance products, each associated with a respective line of business and jurisdictional compliance information;
one or more servers operationally connected to the at least one database, the servers configured to:
a) implement a rules engine to process the rule sets associated with the insurance product data;
b) manage an audit trail for the insurance product data, tracking modifications over time;
c) provide an interface for the configuration of insurance product versions based on state-specific regulations and effective dates;
d) facilitate communication with external systems for filing and compliance verification; and
one or more client devices in communication with the one or more servers, the client devices configured to enable user interaction with the system, wherein users are permitted to:
a) access and review the insurance product data stored in the at least one database;
b) initiate and manage product version upgrades;
c) customize workflow processes according to predefined user roles and permissions;
d) utilize a document management interface to modify and manage insurance product forms in alignment with the respective line of business and jurisdictional requirements.

2. The system of claim 1, wherein the customizable workflows are configurable based on predefined user roles and permissions.

3. The system of claim 1, further comprising an API connector layer, wherein the one or more servers are configured to integrate with external systems including policy administration systems, risk management systems, rating workbooks, document management systems, rules repositories, and the System for Electronic Rate & Form Filing (SERFF), to facilitate communication and data exchange.

4. The system of claim 3, wherein the one or more servers are further configured to maintain structured data schema to organize information related to insurance products, user profiles, audit trails, and other relevant entities utilizing normalization techniques and indexing.

5. The system of claim 1, wherein the one or more servers include security measures comprising one or more of: encryption protocols, access controls, and secure communication channels.

6. The system of claim 1, wherein the one or more servers are configured to track all changes made to insurance products.

7. The system of claim 1, further comprising a rules engine integration, wherein the one or more servers are configured to synchronize rule-related data between the system and an integrated rules engine in real-time through the API connectors.

8. The system of claim 1, wherein the at least one database is further configured to store a versioned history of business rules, and the one or more client devices are configured to access and manage these rules, including modifications and version control.

9. The system of claim 1, wherein the one or more servers are further configured to enable the manual uploading of rules from documentation, utilizing document parsing capabilities to extract and structure rules from textual documents for inclusion in the at least one database.

10. The system of claim 1, further comprising a user interface for rule definition and modification, wherein the one or more client devices are configured to define and modify business rules through form-based input, including the entry of rule parameters, conditions, and actions.

11. The system of claim 1, wherein the one or more servers are further configured to integrate with forms and document management systems to facilitate the retrieval, storage, and modification of insurance policy forms, with the system capturing and storing both original and modified forms within the at least one database.

12. The system of claim 11, wherein the one or more servers are further configured to store modified forms in a centralized location, communicate with forms management personnel for review and approval of the modified forms, and automate the workflow for form approval processes.

13. The system of claim 1, wherein the one or more client devices are configured to allow users to make adjustments and modifications to insurance products based on specific lines of business, with consideration for regional regulations and variations in coverage.

14. The system of claim 1, wherein the one or more servers are further configured to implement analytical capabilities to track the performance of insurance products, including the generation of reports on key metrics for data-driven decision-making.

15. The system of claim 1, wherein the one or more servers are configured to integrate with external data sources for real-time information to enhance risk assessments and product management decisions related to insurance products.

16. The system of claim 1, further comprising a feature for chatbot integration, wherein the one or more servers are configured to process inquiries related to insurance products and provide responses via the chatbot using data from the at least one database.

17. The system of claim 1, wherein the one or more servers are configured to implement models for predicting customer behaviour and likelihood of policy renewals.

18. The system of claim 1, wherein the one or more servers are configured to implement a recommendation engine that suggests product modifications to users based on market trends, regulatory changes, and historical data extracted from the at least one database.

19. The system of claim 1, wherein the one or more servers are further configured to integrate tools for monitoring changes in regulatory requirements, automatically updating insurance products within the at least one database to ensure ongoing compliance.
